(19) United States
(12) Patent Application Publication
(10) Pub. No.: US 2010/0049561 A1
(43) Pub. Date: Feb. 25, 2010

(54) FLUIDIZED BED COMBUSTION OPTIMIZATION TOOL AND METHOD THEREOF

(75) Inventors: Xinsheng Lou, West Hartford, CT (US); Carl H. Neuschaefer, Enfield, CT (US); Paul J. Panos, Windsor, CT (US); Joseph W. Quinn, Bloomfield, CT (US)

Correspondence Address: CANTOR COLBURN, LLP - ALSTOM POWER, 20 Church Street, 22nd Floor, Hartford, CT, 06103, US

(73) Assignee: ALSTOM TECHNOLOGY LTD., Baden (CH)

(21) Appl. No.: 12/196,544

(22) Filed: Aug. 22, 2008

(51) Int. Cl. G06Q 10/00; G06G 7/63; G06G 7/57; G06N 3/10; G06Q 50/00; G06N 3/12; G06F 17/00; G06G 7/635

(52) U.S. Cl. 705/7; 703/7; 703/9; 706/19; 706/13; 700/291

(57) ABSTRACT

A device for optimizing a modeled fluidized bed combustion power plant (10) includes a model (112) of a fluidized bed combustion system and an optimizer (114). The model (112) of the fluidized bed combustion system provides at least one simulated output parameter of the fluidized bed combustion power plant (10) in response to a user selected parameter of the fluidized bed combustion power plant (10). The optimizer (114) provides at least one optimized simulated output parameter of the fluidized bed combustion power plant (10) in response to at least one user selected optimization setting (126) and the at least one simulated output parameter.

### TECHNICAL FIELD

The present disclosure relates generally to the optimization of a fluidized bed combustion process and, more particularly, a tool and a method for analyzing and optimizing a fluidized bed combustion process using design of experiments, neural network modeling and optimization techniques.

### BACKGROUND

Fluidized bed combustion (FBC) is a combustion technology used in power plants primarily to burn solid fuels. FBC power plants are more flexible than conventional power plants in that they can be fired on coal, coal waste or biomass, among other fuels. The term FBC covers a range of fluidized bed processes, including circulating fluidized bed (CFB) boilers, bubbling fluidized bed (BFB) boilers and other variations thereof. Fluidized beds suspend solid fuels on upward-blowing jets of air during the combustion process, resulting in turbulent mixing of gas and solids. The tumbling action, much like a bubbling fluid, provides a means for more effective chemical reactions and heat transfer.

Fluidized-bed boilers evolved from efforts to find a combustion process able to control pollutant emissions without external emission controls (such as scrubbers). During the combustion process of fuels which have a sulfur-containing constituent, e.g., coal, sulfur is oxidized to form primarily gaseous SO₂. In particular, FBC reduces the amount of sulfur emitted in the form of SO₂ by a desulfurization process. A suitable sorbent, such as limestone containing CaCO₃, for example, is used to absorb SO₂ from flue gas during the combustion process. In order to promote both combustion of the fuel and the capture of sulfur, FBC power plants operate at temperatures lower than conventional combustion power plants. Specifically, FBC power plants typically operate in a range between about 850° C. and about 900° C. Since this allows coal to combust at cooler temperatures, NOₓ production during combustion is lower than in other coal combustion processes.

Boiler systems of FBC power plants are generally associated with limestone feed systems for sulfur capture. Processed limestone fed to a boiler is typically conditioned by means of size reduction machines to specific size ranges to allow for the desulfurization process to proceed efficiently.

An air system in an FBC power plant is designed to perform many functions. For example, air is used to fluidize the bed solids consisting of fuel, fuel ash and sorbent, and to sufficiently mix the bed solids with air to promote combustion, heat transfer and control (reduction) of emissions (e.g., SO₂, CO, NOₓ and N₂O). In order to accomplish these functions, the air system is configured to inject air, generally defined as either primary air (PA) or secondary air (SA), at various locations and at specific velocities and quantities.

A distributed control system (DCS) is generally used to control the processes described above in an FBC power plant, based upon operator input. To this end, an operator adjusts FBC system parameters in an attempt to maintain optimal operating conditions. For example, the operator adjusts the FBC system parameters in order to maximize combustion of the fuel with minimal SO₂ emissions. While the operator may have significant experience working with a given FBC power plant, it is difficult to provide the operator with practical tools to assess interplay and/or tradeoffs between numerous operating parameters. Further, the FBC process involves interactions between many variables, as described above, some of which can be manipulated or controlled, and others which cannot be manipulated or controlled. In addition, many of the variables in the FBC process are nonlinear and/or have complex relationships with other variables. As a result, models which effectively simulate these multi-interdependent variable relationships have thus far been inaccurate, inefficient and difficult and/or time consuming to work with.

Therefore, most FBC power plants currently use testing based on a trial and error approach in attempting to determine optimum plant operating conditions. The results of such testing depend significantly on the experience level of personnel performing the tests, among other things. Furthermore, testing time is generally restricted, since changing plant conditions to perform the tests may have undesired affects on plant operations, such as increasing SO₂ emissions and/or reducing combustion efficiency of the fuel. As a result of the limited testing time, the trial and error approach normally does not include sufficient variations in plant parameters to obtain statistically significant results. Accordingly, these empirical diagnostic determinations based upon the trial and error approach are generally inaccurate.

Although some offline optimization tools have been developed, these are focused on optimizing conventional combustion power plants. Furthermore, these optimization tools have been focused on solving very specific, localized optimization problems rather than global optimization of plant operations. Thus, a more systematic approach, e.g., an approach utilizing design of experiments (DOE), has been suggested to provide broader results. However, the associated statistical analysis for conventional combustion power plants is based upon an assumption of linear relationships between variables. As a result, the associated statistical analysis for conventional combustion power plants is inaccurate when used to analyze the complex, nonlinear dynamics of an FBC process.

Neural network (NN) modeling has also been used for conventional power plants such as pulverized coal combustion power plants, but implementing NN modeling for an FBC power plant has thus far required a prohibitive amount of time and effort. This is primarily due to a need to collect a statistically significant amount of test data to develop a validated NN model for the more complex process dynamics associated with the FBC power plant.

Accordingly, it is desired to develop an FBC power plant optimization tool which overcomes the problems described above.

### SUMMARY

According to the aspects illustrated herein, there is provided a device for optimizing a modeled fluidized bed combustion power plant. The device includes a model of a fluidized bed combustion system and an optimizer. The model of the fluidized bed combustion system provides at least one simulated output parameter of the fluidized bed combustion power plant in response to a user selected parameter of the fluidized bed combustion power plant. The optimizer provides at least one optimized simulated output parameter of the fluidized bed combustion power plant in response to at least one user selected optimization setting and the at least one simulated output parameter.

According to the other aspects illustrated herein, a method for optimizing a modeled fluidized bed combustion power plant includes: receiving user selected parameters of the fluidized bed combustion power plant; receiving at least one user selected optimization setting; providing at least one simulated output parameter of the fluidized bed combustion power plant using a model of a fluidized bed combustion system in response to a user selected parameter of the fluidized bed combustion power plant; optimizing at least one optimized simulated output parameter of the fluidized bed combustion power plant in response to the at least one user selected optimization setting and the at least one simulated output parameter; and providing the at least one optimized simulated output parameter of the fluidized bed combustion power plant to a user.

According to still other aspects illustrated herein, an optimization tool for optimizing a fluidized bed combustion process includes a model, a genetic algorithm optimizer, a prediction module, a sensitivity analysis module, an optimization module, a user interface including one or more of symbols, images and icons, an input interface which inputs input data to the model, and an output interface which outputs processed data from at least one of the prediction module, the sensitivity analysis module and the optimization module. The input data includes at least one of fuel flow, limestone flow, primary air flow, secondary air flow, secondary air head pressure, combustor differential pressure, load demand, fuel property, ambient temperature, bed temperature, oxygen level, fly ash reinjection rate, historical test data, design test data, heat rate, loss on ignition, CO₂ capture cost, CO₂ processing cost, CO₂ transportation cost, CO₂ storage cost, CO level, NOₓ level, NOₓ trade price, NOₓ trade price (in ozone season), SOₓ level, SOₓ trade price, fuel cost, fuel flow, limestone cost, limestone flow, ash disposal cost and ash flow.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 is a block diagram of an exemplary fluidized bed combustion (FBC) power plant known in the art;

FIG. 2 is a block diagram of an optimization tool for an FBC power plant in accordance with the present invention;

FIG. 3 is a block diagram illustrating a functional design of the optimization tool for an FBC power plant in accordance with the present invention;

FIG. 4 is a block diagram of a software architecture of an optimization tool in accordance with the present invention;

FIG. 5 is a graph of a multi-dimensional problem space illustrating example constraints and optimized variables of an FBC power plant in accordance with the present invention; and

FIG. 6 is a screenshot of a spreadsheet software application of the optimization tool for an FBC power plant in accordance with the present invention.

### DETAILED DESCRIPTION

Disclosed herein is an optimization tool or device 100 for analysis, simulation and optimization of the combustion process of a modeled fluidized bed combustion (FBC) power plant. The optimization tool provides design and installation personnel (performance and commissioning staff) and external customers (power plant engineers and managers) with a user-friendly methodology and software tool for off-line evaluation and optimization, economic analysis and decision support for production management. The tool is helpful to obtain insights into the process behavior through simulation and sensitivity analysis.

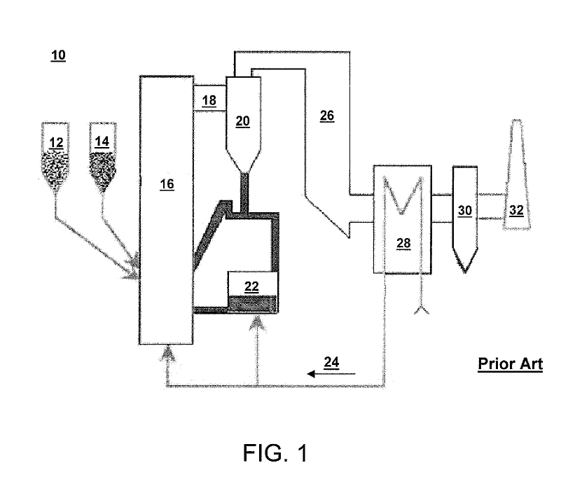

Referring to FIG. 1, a fluidized bed combustion power plant 10 includes a fuel source 12 and an additive source 14, which respectively provide fuel (e.g., coal) and an additive(s) (e.g., limestone) to an FBC furnace 16. A flue duct 18 connects the FBC furnace 16 to a particulate separator 20 (e.g., a cyclone) and an FBC heat exchanger 22, such as a fluidized bed heat exchanger (FBHE). Air 24 is provided to the FBC furnace 16 and the FBHE 22 to fluidize the respective beds. Combustion gases from the FBC furnace 16 pass through the flue duct 18 and cyclone 20 into an economizer 26 before passing through an air pre-heater 28, a baghouse 30, and finally onto a stack 32 through which the combustion gases are exhausted to the atmosphere. Particulates (e.g., solid particles of fuel) entrained in the combustion gases leaving the FBC furnace 16 through the flue duct 18 are separated by the cyclone 20, which are then returned to the FBC furnace 16 via the FBHE 22, as shown in FIG. 1. The baghouse 30 removes flyash from the flue gas, wherein the flyash may be disposed of and/or returned to the furnace 16.

In an exemplary embodiment, the FBC furnace 16 is a circulating fluidized bed (CFB) boiler or a bubbling fluidized bed (BFB) boiler. Further, the FBC power plant 10 according to an exemplary embodiment is not limited to the components shown in FIG. 1, but may include, but not limited to, other components such as an air pollution control (APC) system, a flash dryer absorber (FDA), a spray dryer absorber (SDA), a flue gas desulfurization (FGD) system and/or an electrostatic precipitator (ESP), for example, as known in the art.

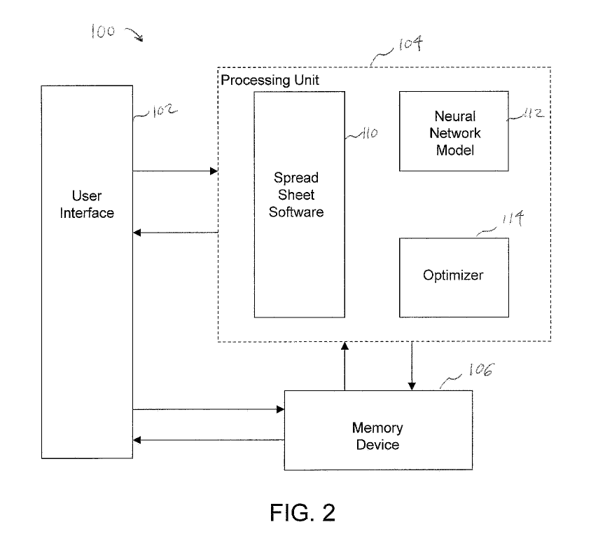

An optimization tool 100 for the FBC power plant 10 will now be described in further detail with reference to FIGS. 2-4. According to an exemplary embodiment, the optimization tool 100 enables a user to predict FBC process output variables for a modeled FBC plant, perform input/output variable sensitivity analysis, calculate economic values for predicted operating conditions, and optimize the modeled FBC process, which includes the calculation of a set of process inputs that minimizes a cost function or process outputs and constraints, as will be described in greater detail hereinafter.

As shown in FIG. 2, the optimization tool 100 includes a user interface 102, a processing unit 104, and a memory device 106. The user interface 102 includes a keyboard (not shown) and/or other input device (e.g. a keypad, mouse, and/or an input port) to communicate with and input data into the processing unit 104 and memory device 106. The user interface 102 also includes a display and/or other output device (e.g., a printer and/or an output port) to communicate results, analyses, and/or other information provided by the processing unit 104 and/or stored in the memory device 106. The memory device 106 stores information provided by the user interface 102 and the processing unit 104, such as the input data provided by the user and processing code, data and results provided by the processing unit 104. The processing unit 104 processes a spreadsheet software 110 (e.g., EXCEL®), a neural network (NN) model 112, and an optimizer 114, which will be described in greater detail hereinafter. In one embodiment, the optimization tool 100 may be a computer or laptop computer, as well as integrated into the distributed control system (DCS) of the FBC plant.

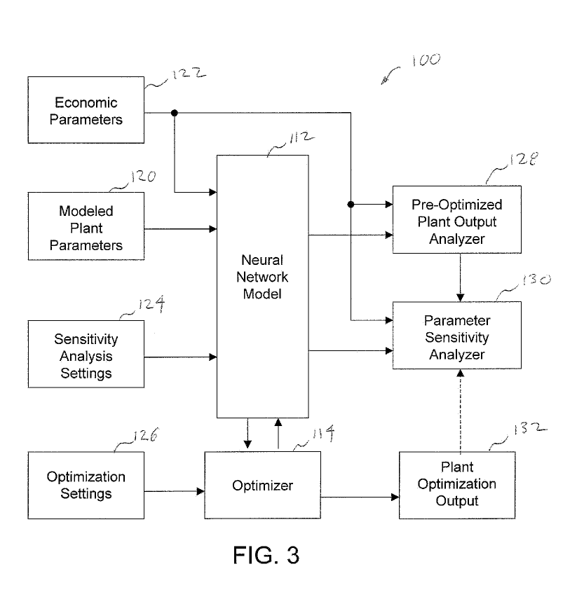

FIG. 3 illustrates a functional diagram of the optimization tool 100. As mentioned hereinbefore, the optimization tool 100 includes the neural network (NN) model 112 and the optimizer 114. In general, the user inputs modeled plant parameters 120, economic parameters 122, sensitivity analysis settings 124, and optimization settings 126 into the optimization tool 100 through the user interface 102 (see FIG. 2). The modeled plant parameters 120 and sensitivity analysis settings 124 are provided to the NN model 112. The modeled plant parameters 120 may include both plant input parameters and plant output parameters. The modeled plant parameters 120 may include, for example, primary air flow (PA_Flow), oxygen level (O2 Level) secondary head air head pressure (SA Head Pressure), low bed temperature (Low Bed Temp), combustor differential pressure (Combustor DP), coal feed percentage (Perc_of_Coal), limestone feed percentage (Perc_of_LS), ambient temperature (Ambient Temp) fly ash re-injection (Fly_Ash_Reinj), mass waste demand (MW_DMD), process steam flow (PS_Flow), crusher number (Crusher_NUM), bar pressure (Bar Pressure), NOₓ emission (Boiler NOₓ), total fuel rate (Fuel_Total), and total limestone feed rate (LS_Fuel). In another exemplary embodiment, the modeled plant parameters 120 may include fuel flow, limestone flow, primary air (PA) flow, secondary air (SA) flow, SA head pressure, combustor differential pressure, load demand, fuel property, ambient temperature, bed temperature, oxygen level and/or fly ash reinjection rate, but are not limited thereto.

Furthermore, one skilled in the art would appreciate that the other modeled plant parameters 120 may be used, including parameters associated with an air pollution control (APC) system, a flash dryer absorber (FDA), a spray dryer absorber (SDA), a flue gas desulfurization (FGD) system and/or an electrostatic precipitator (ESP). The sensitivity analysis settings 124 include a range of parameters for one or more selected modeled plant parameters 120, which will be described in greater detail hereinafter.

The NN model 112 processes the modeled plant parameters 120 according to predetermined historical and design data, discussed in greater detail below, and provides the output data to a pre-optimized plant output analyzer 128. The pre-optimized plant output analyzer also receives economic parameters 122 to provide a prediction of the FBC process input and/or output parameters, which will be described in greater detail hereinafter. The output data includes, for example, predicted coal feed rate, NOₓ output, limestone feed rate, and economic cost, as well as input parameters of the modeled plant. The economic parameters 122 include, for example, fuel and limestone costs, as well as heat rate, loss on ignition, CO₂ capture cost, CO₂ processing cost, CO₂ transportation cost, CO₂ storage cost, CO level, NOₓ level, NOₓ trade price, NOₓ trade price (in ozone season), SOₓ level, SOₓ trade price, ash disposal cost and ash flow may also be inputted as trial plant parameters 200, but are not limited to the foregoing.

The NN model 112 further processes the sensitivity analysis settings 124, which define a range of selected modeled plant parameters 120. The NN model 112 provides associated predicted plant output parameters over the range of the sensitivity settings 124 to a parameter sensitivity analyzer 130. The economic parameters 122 may also be provided to the parameter sensitivity analyzer 130. In response to the range of predicted plant output parameters and the economic parameters 122, the parameter sensitivity analyzer 130 provides a predicted output indicative of the sensitivity of the plant to changes of the selected plant input parameters over the selected range(s), and also an output of the sensitivity of the economic cost of operating and/or performance of the modeled FBC plant to changes in the selected modeled plant parameters 120, which will be described in greater detail hereinafter.

The NN model 112 further interfaces with the optimizer 114 that provides an output indicative of values for one or more modeled plant parameters 120 to optimally operate the modeled FBC plant in accordance with the optimizations settings 126 inputted into the optimizer 114. Additionally, the economic parameters 122 may be provided to determine the cost of operating the optimized system. The optimization settings 126 include constraints of the modeled plant input and/or output parameters 120 and/or economic parameters 122.

The optimizer 114 uses a global heuristic search algorithm, described in greater detail below, to determine output optimized plant parameters provided by a plant optimization output module 132. The optimized plant parameters may then be used or applied to the FBC power plant 10 to optimize the operation and performance of the power plant. In an exemplary embodiment, the optimization tool 100 is used as a stand alone device to analyze the operation of the modeled plant, simulate the operation and performance of the modeled plant under different plant parameters 120, and/or optimize the operation and performance of the modeled plant. More specifically, the optimization tool 100 is not connected to the FBC power plant 10. As a result, sensitivity and/or economic analysis may be performed without affecting operation of the FBC power plant 10. The optimized plant parameters determined offline may, however, be subsequently manually implemented by an operator of the FBC power plant 10, either manually or by electronic communication between the optimization tool 100 and the FBC plant 10.

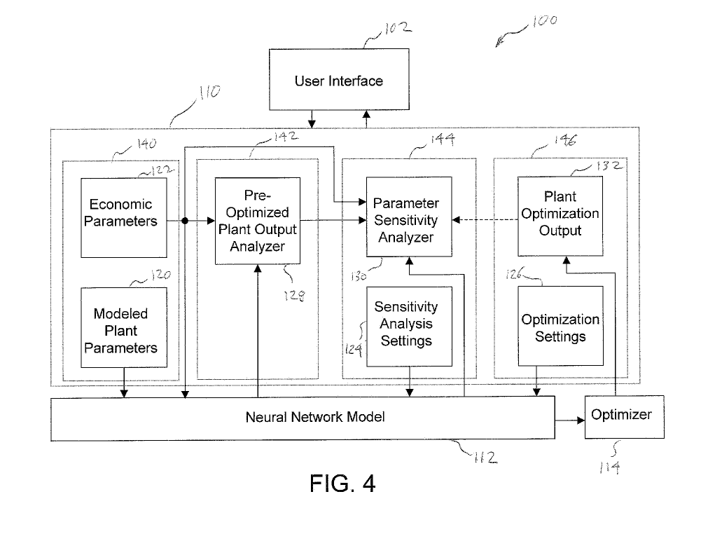

As shown in FIG. 4, the software architecture of the spreadsheet software 110 includes an input data module 140, a prediction module 142, a sensitivity module 144, and an optimization module 146. The spreadsheet software 110 interfaces with the user interface 102, the NN module 112 and optimizer 114. The input data module 140 includes the modeled plant parameters 120 and the economic parameters 122. The prediction module 142 includes the pre-optimized plant output analyzer 128. The sensitivity module 144 includes the sensitivity analysis settings 124 and the parameter sensitivity analyzer 130. The optimization module 146 includes the optimization settings 126 and the plant optimization output module 132.

Based upon the modeled plant parameters 120 which are inputted to the NN model 112, the optimized plant parameters are determined by the NN model 112 and the optimizer 114. The optimized plant parameters provided by the plant optimization output module 132 include oxygen level, fuel flow and/or limestone flow, but are not limited thereto. The optimized plant parameters may be used to operate the FBC power plant 10 such that limestone and fuel are utilized most efficiently, while emissions are minimized, thereby improving operational and/or economic efficiency of the FBC power plant 10.

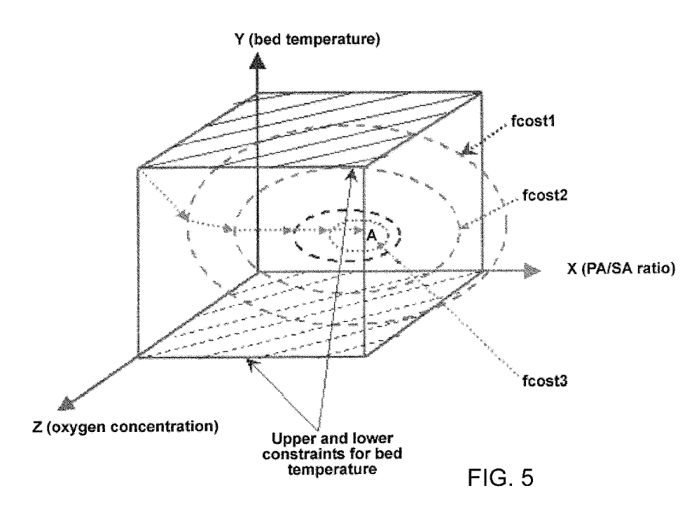

FIG. 5 illustrates an example partial set of pre-optimized plant parameters of the pre-optimized plant output analyzer 128 of FIG. 3 for the modeled FBC power plant. More specifically, in FIG. 5, the “X” axis represents a PA/SA ratio, the “Y” axis represents bed temperature and the “Z” axis represents an oxygen concentration in the FBC furnace 16. The oxygen concentration is dependent upon both the PA/SA ratio and the bed temperature. Cost functions fcost1, fcost2 and fcost3 correspond to associated combinations of PA/SA ratio, bed temperature and oxygen concentration. One such cost function is: fcost=cost of limestone+cost of NOₓ+cost of fuel=(c₁*limestone feed rate)+(c₂*NOₓ emission rate)+(C₃*fuel feed rate), wherein c₁, c₂ and C₃ are unit costs for the three variables: limestone feed rate, NOₓ emission rate, and fuel feed rate. In an exemplary embodiment, c₁, c₂ and C₃ are constants in a given period of operating time, but are subject to change as market prices and/or emission regulations change. It should be noted that the partial set of pre-optimized plant parameters shown in FIG. 5 is not inclusive; rather, the three parameters PA/SA ratio, bed temperature and oxygen concentration have been shown for purposes of illustration and simplicity.

Referring to the cost functions fcost1, fcost2 and fcost3 shown in FIG. 5, it can be seen that as an optimal combination, indicated by point A in FIG. 5, is approached, as cost decreases, e.g., fcost1>fcost2>fcost3.

Expanding this concept and referring again to FIGS. 2, 3 and 5, the NN model 112 and the optimizer 114 determine a minimized cost function (fcost3), based upon a given set of pre-optimized modeled plant parameters 120. As noted above, the optimization tool 100 according to an exemplary embodiment is not limited to three variables, as shown in FIG. 5, but is capable of more complex analysis, as will now be described in further detail.

In general, a neural network includes a group of nodes, or processing elements, interconnected to form a network. A mathematical algorithm is used to determine interactions between the nodes as a signal travels from an input node or nodes, “through” the network and on to an output node or nodes. Further, the algorithm may, over time, alter a preference for interactions between the nodes. As a result, the neural network is effectively an adaptive model. Thus, the neural network adaptively models complex relationships between inputs and outputs.

Likewise, the NN model 112 of the optimization tool 100 is a multivariate, nonlinear model. More specifically, the NN model 112 uses process data, e.g., the modeled plant parameters 120, to develop an input-output model capable of analyzing a multiple-variable process wherein relationships between variables are complex and nonlinear. Further, the input-output model developed by the NN model 112 is adaptive, as described above, and is therefore based upon learning as opposed to first principles such as explicit equations. As a result, the NN model 112 has a reduced complexity in comparison to conventional analytical models. Consequently, the complex, nonlinear process dynamics of the FBC power plant 10 can be sufficiently analyzed and modeled more effectively, with a reduced demand for testing resources to obtain empirical FBC process data. In addition, the NN model 112 can be easily adapted for other FBC power plants by re-training the NN model 112 for the other FBC power plants.

Historical plant data is used to develop the NN model 112. The NN model is further developed with designed test data obtained using design of experiments (DOE) methodology. In DOE, various effects of factors in a process, as well as interactions of the factors themselves, are efficiently analyzed. This is accomplished by selecting varying input combinations and measuring the output effects of the selected input combinations. Using DOE ensures that sufficient variations in test data are obtained to achieve accurate optimization by the optimizer 114 of data modeled by the NN model 112. At the same time, requirements for physical testing, e.g., trial and error type testing, are substantially reduced or effectively minimized. Therefore, empirical data sufficient to accurately develop the NN model 112 is obtained more efficiently and with minimal variation in operation or down time of the FBC power plant 10.

Still referring to FIGS. 2, 3, and 5, the optimizer 114 of the optimization tool 100 will now be described in further detail. In an exemplary embodiment, the optimizer 114 utilizes a genetic algorithm (GA). More specifically, the GA functions as a heuristic global search algorithm which solves a constrained optimization problem such as minimizing a cost function of the FBC power plant 10, as described above. Further, the GA of the optimizer 114 is designed to analyze continuous variables such as fuel flow, as well as discrete variables such as individual switch positions and/or settings of the FBC power plant 10. As a result, the optimizer 114 is capable of performing mixed integer GA optimization. Further still, operator-observed data, e.g., heuristic knowledge of plant staff, can be incorporated into the GA such that the operator can adjust the optimizer 114 based upon prior experience. This allows the operator to further adjust and analyze optimization results.

In alternative exemplary embodiments, the optimizer 114 maybe a global optimization algorithm optimizer which utilizes any global optimization algorithm or method using stochastic and/or deterministic and/or heuristic search mechanisms, but is not limited thereto.

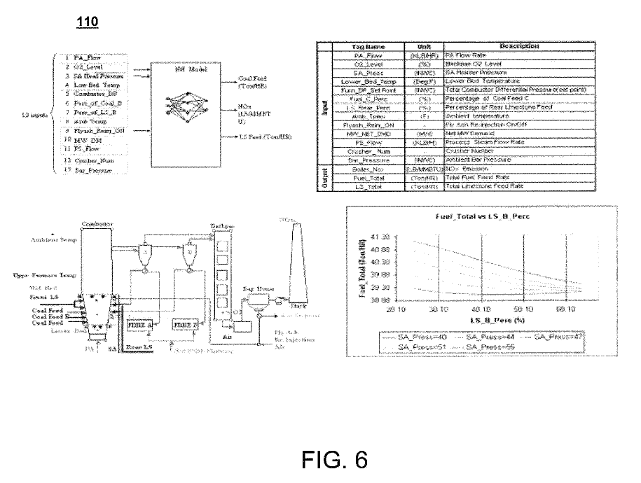

As discussed hereinbefore, the optimization tool 100 is implemented in a spreadsheet software 110 such as EXCEL®, as illustrated in FIG. 6, but is not limited thereto. More specifically, the NN model 112 is implemented with the spread sheet software 110 along with the prediction module 142, the sensitivity analysis module 144 and the optimization module 146. The user interface 102 provides data input and output capability, as well as display and other functions associated with using the optimization tool 100. In an exemplary embodiment, the user interface 102 includes symbols, images and/or icons (FIG. 6) which the operator uses to enter the modeled plant parameters 120, adjust settings and operation of the optimization tool 100 and view output of the optimization tool 100. As a result, the operator can conveniently manipulate variables, e.g., the modeled plant parameters 120, associated with the optimization tool 100. Further, no additional and/or specific training or software expertise is required of the operator to manipulate the variables and evaluate resulting outputs of the optimization tool 100, as will be described in further detail below.

Referring to FIGS. 2-4 and 6, the prediction module 142 allows an operator to input trial modeled plant parameters 120 to the optimization tool 100 to determine the pre-optimized plant parameters provided by the pre-optimized plant output analyzer 128. More specifically, the operator inputs different combinations of trial modeled plant parameters 120 (such as fuel flow and limestone flow, for example) to obtain pre-optimized plant parameters and/or pre-optimized plant parameter charts and/or graphs illustrating pre-optimized modeled plant parameters 120. Therefore, the operator is able to use the prediction module 142 to perform economic analysis to determine a pre-optimized economic cost, for example, of operating the modeled FBC power plant under different operating conditions. The economic analysis is also useful for comparison with optimized plant parameters obtained from the optimization module 146, as described below in further detail.

For example, the user may manipulate various modeled plant parameters 120 (e.g., input and output plant parameters and economic parameters) to determine and analyze the effect of the changes to the resulting predicted output parameters of the modeled plant. The tool 100 enables a user to vary or tune the plant parameters 120 to provide the desired output parameters.

The sensitivity module 144 allows the operator to analyze an affect of changing one or more modeled plant parameters 120 on the pre-optimized plant output parameters of the pre-optimized plant output analyzer 128 and/or the optimized plant parameters. More specifically, the operator varies one or more of the modeled plant parameters 120 to determine a relative affect that the variation has on the pre-optimized plant parameters of the prediction module 142 and or the optimized plant parameters of the optimization module 146. The affect of the variation is displayed as a sensitivity analysis output (not shown). Therefore, the operator is able to obtain insight into relationships between specific variables associated with the modeled FBC power plant.

The operator controls operation and settings of the sensitivity module 144 by adjusting the sensitivity analysis settings 124. More specifically, in an exemplary embodiment the operator adjusts the sensitivity analysis settings 124 such that a sensitivity of at least one pre-optimized modeled plant parameter 120 and/or at least one optimized plant parameter of the plant optimization output is determined based upon a variation of one of the modeled plant parameters 120, while all other modeled plant parameters 120 are held constant. In this case, a sensitivity report (not shown) is generated. The sensitivity report includes a sensitivity output worksheet having the sensitivity analysis output, as well as a sensitivity curve worksheet having plots and/or curves of the sensitivity analysis output.

In an alternative exemplary embodiment, the operator adjusts the sensitivity analysis settings 124 to determine relative sensitivities of one pre-optimized modeled plant parameter 120 or one optimized plant parameter and a single modeled plant parameter 120 while the other modeled plant parameters 120 are held constant. In this case, the sensitivity report (not shown) includes a sensitivity focus worksheet and a sensitivity rank worksheet. The focus worksheet and the sensitivity rank worksheet illustrate outputs such as average absolute sensitivity, average sensitivity and peak sensitivity of the one pre-optimized plant parameter or one optimized plant parameter and the single modeled plant parameter 120, for example, but are not limited thereto.

The optimization module 146 optimizes the modeled plant parameters 120 inputted to the NN model 112 to output the optimized plant parameters in accordance with operator-adjusted optimization settings 126. Subsequently, the operator may apply the optimized plant output to a FBC power plant 10, resulting in optimization of the plant. Alternatively, the optimized plant output may be provided directly, e.g., automatically, to the FBC power plant 10 from the optimization module 146. As a result, the plant output characteristics are optimized without requiring the operator to manually apply the optimized plant parameters to the FBC power plant 10.

In an exemplary embodiment, the prediction model 142, the sensitivity analysis module 144 and/or the optimization module 146 includes an economic cost model (not shown). The economic cost model may be a separate component or integral to the prediction model 142, the sensitivity analysis module 144 and/or the optimization module 146. Further, the economic cost model optimizes the predicted pre-optimized plant parameters of the prediction module 142 to determine economically-optimal optimized plant parameters for a given operating condition such as an ozone season operating mode or a non-ozone season operating mode, for example, of the FBC power plant 10.

For example, the user may select for a desired optimization simulation scenario certain input variables that may be manipulated and other input variables may be fixed or otherwise clamped to their original values. Such manipulated variables may include primary air flow rate (PA_Flow), oxygen level (O2_Level), lower bed temperature (Low Bed Temp), secondary air head pressure (SA Head Pressure), furnace differential or steady pressure (Combustor DP), limestone feed percentage (Perc_of_LS Feed A), and coal feed percentage (Perc_of_Coal Feed B). Such fixed variables may include mass weight demand (MW_DMD), process steam flow (PS_Flow), ambient temperature (Ambient Temp), bar pressure (Bar Pressure), crusher number (Crusher_Num), and fly ash reinjection state (Fly_Ash_Reinj_ON). The output parameters may include the coal feed rate, limestone feed rate and amount of NOₓ. The tool enabling the user to select the input variables to be used in the simulation, and which of the input variables are fixed or manipulated.

In addition to the components described in further detail above, the optimization tool 100 according to an exemplary embodiment further includes or is utilized with computer hardware and/or software components or systems, including a processor, storage medium, video display, keyboard, mouse, and memory, for example, but alternative exemplary embodiments are not limited thereto.

In summary, the optimization tool 100 according to an exemplary embodiment utilizes DOE and nonlinear NN concepts to optimize operating parameters of a modeled FBC power plant. More specifically, by utilizing a systematic approach to test design, data processing, problem diagnosis and combustion performance optimization, the optimization tool 100 integrates the advantages of NN modeling and DOE techniques to determine global optimization of complex, multivariate nonlinear parameters with a minimized demand for testing resources. Thus, sufficient variations in plant parameters are measured and/or tested to provide an accurate model of FBC power plant processes while minimizing testing costs.

Further, the optimization tool 100 allows users to select different values of process model input variables to generate performance predictions for pre-defined modeled plant parameters 120. The predictions can be used to compute economic cost savings based on unit-specific prices (e.g., fuel price, limestone price, extra processing costs, NOₓ trade price, SO₂ trade price, etc.). The optimization tool 100 also generates process input/output sensitivity curves or data to help the user obtain insights into the relations between the input variables and the output performance variables. The tool also allows users to perform batch prediction “what-if” simulations by defining a “test matrix” with multiple changes to those inputs of the user's particular interests to generate a series of performance prediction values and economic numbers and curves. With such information, a user will be able to more easily select an optimal operating condition and perform better production management of a FBC power plant.

Using the optimization tool 100, engineers, operators and managers can easily perform advanced optimization tasks which normally require specialized knowledge, tools and training by using a simple spreadsheet software application.

Further, the NN model 112 of the optimization tool 100 uses a genetic algorithm which does not require explicit equations, thus providing the advantages of simplicity and flexibility of implementing the model for additional FBC power plants without extensive re-testing as would be required for other models which require explicit equations.

One will appreciate that the optimization tool 100 can predict and optimize input and/or output parameters of the modeled plant parameters 120.

It will be further appreciated that, while exemplary embodiments described herein have made reference to neural network models, alternative exemplary embodiments are not limited thereto. For example, alternative exemplary embodiments may include, but are not limited to, an empirical model (to include a multivariate nonlinear neural network model), a physical model (to include a first principle model), and/or a combination of an empirical model and a physical model.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A device for optimizing a modeled fluidized bed combustion power plant, the device comprising:
a model of a fluidized bed combustion system which provides at least one simulated output parameter of the fluidized bed combustion power plant in response to a user selected parameter of the fluidized bed combustion power plant; and
an optimizer which provides at least one optimized simulated output parameter of the fluidized bed combustion power plant in response to at least one user selected optimization setting and the at least one simulated output parameter.

2. The device of claim 1, wherein the model comprises a neural network model.

3. The device of claim 1, wherein the model comprises one of an empirical model, a physical model, and/or a combination of an empirical model and a physical model.

4. The device of claim 1, wherein the optimizer comprises a genetic algorithm optimizer.

5. The device of claim 1, wherein the user selected parameter includes input and/or output parameters of the fluidized bed combustion power plant.

6. The device of claim 5, wherein the user selected input parameters includes economic parameters associated with the fluidized bed combustion power plant.

7. The device of claim 1, wherein the at least one simulated output parameter includes an input and/or output parameter of the fluidized bed combustion power plant.

8. The device of claim 1 further comprising a prediction module which provides predicted input and/or output parameters of the fluidized bed combustion power plant in response to the at least one simulated output parameter.

9. The device of claim 8, wherein the prediction module provides predicted input and/or output parameters of the fluidized bed combustion power plant in response to the at least one simulated output parameter and an economic parameter associated with the fluidized bed combustion power plant.

10. The device of claim 1, wherein the model of the fluidized bed combustion system provides at least one simulated output parameter of the fluidized bed combustion power plant in response to user selected parameters of the fluidized bed combustion power plant and at least one sensitivity analysis setting.

11. The device of claim 10, wherein the at least one sensitivity analysis setting includes a parameter range for a parameter of the fluidized bed combustion power plant.

12. The device of claim 10 further comprising a sensitivity module which provides input and/or output parameters of the fluidized bed combustion power plant in response to the at least one simulated output parameter and the at least one sensitivity analysis setting.

13. The device of claim 12, wherein the sensitivity module provides input and/or output parameters of the fluidized bed combustion power plant in response to the at least one simulated output parameter, the at least one sensitivity analysis setting, and an economic parameter associated with the fluidized bed combustion power plant.

14. The device of claim 1 further comprising an optimization module which provides economically optimized input and/or output parameters of the fluidized bed combustion power plant in response to the at least one optimized output parameter.

15. The device of claim 1 further comprising spreadsheet module which provides an interface with a user, the model and the optimizer.

16. A method for optimizing a modeled fluidized bed combustion power plant, the method comprising:
receiving user selected parameters of the fluidized bed combustion power plant;
receiving at least one user selected optimization setting;
providing at least one simulated output parameter of the fluidized bed combustion power plant using a model of a fluidized bed combustion system in response to a user selected parameter of the fluidized bed combustion power plant;
optimizing at least one optimized simulated output parameter of the fluidized bed combustion power plant in response to the at least one user selected optimization setting and the at least one simulated output parameter; and
providing the at least one optimized simulated output parameter of the fluidized bed combustion power plant to a user.

17. The method of claim 16, wherein the user selected input parameter includes input and/or output parameters of the fluidized bed combustion power plant and/or economic parameters associated with the fluidized bed combustion power plant, and the at least one simulated output parameter includes an input and/or output parameter of the fluidized bed combustion power plant.

18. The method of claim 16 further comprising providing predicted input and/or output parameters of the fluidized bed combustion power plant in response to the at least one simulated output parameter.

19. The method of claim 16, wherein the model of the fluidized bed combustion system provides at least one simulated output parameter of the fluidized bed combustion power plant in response to the user selected parameter of the fluidized bed combustion power plant and at the least one sensitivity analysis setting.

20. The method of claim 16 further comprising providing economically optimized input and/or output parameters of the fluidized bed combustion power plant in response to the at least one optimized output parameter.
